(19) United States
(12) Patent Application Publication
(10) Pub. No.: US 2016/0001492 A1
(43) Pub. Date: Jan. 7, 2016

(54) METHOD OF GENERATING SUPPLY PATTERN DATA OF IMPRINT MATERIAL, IMPRINT METHOD, IMPRINT APPARATUS, AND METHOD OF MANUFACTURING ARTICLE

(71) Applicant: CANON KABUSHIKI KAISHA, Tokyo (JP)

(72) Inventors: Hiromitsu Yamaguchi, Yokohama-shi (JP); Takuro Yamazaki, Utsunomiya-shi (JP); Yasuyuki Tamura, Yokohama-shi (JP); Akio Saito, Machida-shi (JP)

(21) Appl. No.: 14/753,295

(22) Filed: Jun. 29, 2015

(30) Foreign Application Priority Data
Jul. 2, 2014 (JP) 2014-137065
Jun. 3, 2015 (JP) 2015-113352

(51) Int. Cl. B29C 59/00; B29C 33/42

(52) U.S. Cl. CPC B29C 59/002; B29C 33/424; B29L 2007/001

(57) ABSTRACT

A method for generating supply pattern data of an imprint material formed by using a mold is provided. The method includes obtaining, for each of a plurality of different cleaning methods, information concerning of a shape change in a pattern portion of the mold caused by cleaning the pattern portion of the mold. The method further includes generating, based on the obtained information concerning of the shape change corresponding to the cleaning method, the supply pattern data corresponding to the number of cleaning operations.

### BACKGROUND OF THE INVENTION

1. Field of the Invention

The present invention relates to a method of generating supply pattern data of an imprint material, an imprint method, an imprint apparatus, and a method of manufacturing article.

2. Description of the Related Art

An imprint technique is a technique capable of transferring a nanoscale micropattern, and is coming into practical use as one lithography technique for mass production of magnetic storage media and semiconductor devices. A photo-imprint method of curing a resin with light is proposed as the imprint technique. In this method, first, a photo-curing resin layer formed on a substrate such as a silicon wafer or a glass plate and a mold on which a three-dimensional pattern has been formed are brought into contact with each other. Then, they are irradiated with light to cure the resin layer, thereby separating (releasing) the mold from the cured resin layer. By doing so, a three-dimensional pattern (resin pattern) is formed on the substrate. Recently, a method of dispensing a photo-curing resin material by an inkjet method is also proposed.

In Japanese Patent Laid-Open No. 2012-234901, molds are grouped, in order to reduce pattern defects formed on a substrate, by using information on the individual difference in the shape, and the numbers of usage operations and cleaning operations of the molds. Then, a pattern is formed on the substrate in accordance with an imprint condition associated with each group.

Japanese Patent Laid-Open No. 2012-234901, however, does not specifically disclose the imprint condition associated with each group and, in particular, the supply pattern data of a resin.

### SUMMARY OF THE INVENTION

The present invention provides a method of generating supply pattern data, an imprint method, an imprint apparatus, and a method of manufacturing article, advantageous in reducing pattern defects.

According to one aspect of the present invention, a method for generating supply pattern data of an imprint material formed by using a mold is provided. The method includes the steps of obtaining, for each of a plurality of different cleaning methods, information on a shape change in a pattern portion of the mold caused by cleaning the pattern portion of the mold, and generating, based on the obtained information concerning of the shape change corresponding to the cleaning method, the supply pattern data corresponding to the number of cleaning operations.

Further features of the present invention will become apparent from the following description of exemplary embodiments (with reference to the attached drawings).

### BRIEF DESCRIPTION OF THE DRAWINGS

FIG. 1 is a diagram showing the arrangement of an imprint apparatus;

FIG. 2 is a flowchart showing an imprint process according to the first embodiment;

FIG. 3 is a view showing an example of an imprint order with respect to a wafer;

FIG. 4 is a view showing an example of defects detected;

FIG. 5 is a flowchart showing a process related to generation of a resin dispensing pattern;

FIG. 6 is a view for explaining dispensing amount distribution information;

FIG. 7 is a view showing an example of the resin dispensing pattern;

FIG. 8 is a flowchart showing an example of a method of obtaining a temporal change;

FIG. 9 is a view schematically showing correction information;

FIG. 10 is a flowchart showing a process of generating a plurality of resin dispensing patterns based on temporal change information;

FIG. 11 is a view schematically showing corrected dispensing amount distribution information;

FIG. 12 is a view showing an example of a corrected resin dispensing pattern;

FIG. 13 is a flowchart showing an imprint process according to the second embodiment;

FIG. 14 is a view for explaining film thickness measurement;

FIG. 15 is a flowchart showing another example of a method of obtaining a temporal change;

FIG. 16 is a view schematically showing correction information;

FIG. 17 is a flowchart showing an imprint process according to the third embodiment;

FIG. 18 is a flowchart showing an imprint process according to the fourth embodiment;

FIG. 19 is a flowchart showing a method of generating a dispensing pattern according to the fifth embodiment;

FIG. 20 is a table showing the relationship between a cleaning method and a shape change;

FIG. 21 is a flowchart showing an imprint process according to the fifth embodiment;

FIG. 22 is a table showing the relationship of a shape change for each cleaning condition; and

FIG. 23 is a flowchart showing a method of generating a dispensing pattern according to the seventh embodiment.

### DESCRIPTION OF THE EMBODIMENTS

Various exemplary embodiments, features, and aspects of the invention will be described in detail below with reference to the drawings.

Preferred embodiments of the present invention will be described in detail below with reference to the accompanying drawings. Note that the following embodiments are not intended to limit the present invention and are merely concrete examples advantageous in practicing the invention. Also, not all combinations of features to be described in the embodiments are indispensable for the means to solve the problems according to the present invention.

### First Embodiment

### Method of Measuring Defect Positions and Number of Defects as Defect Information

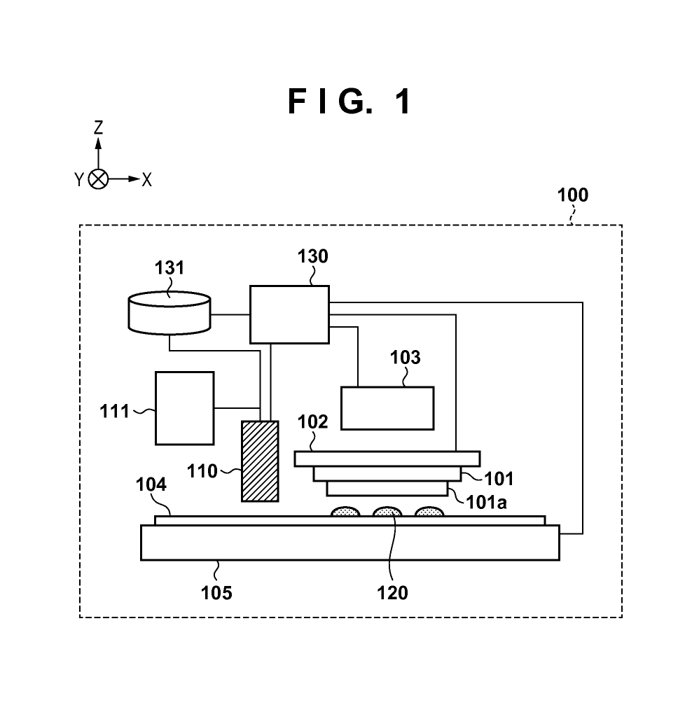

(Description of Imprint Apparatus) FIG. 1 is a diagram showing the arrangement of an imprint apparatus 100 according to this embodiment. The imprint apparatus 100 is a lithography apparatus used for a manufacturing process of a semiconductor device or the like and transfers a mold pattern onto a substrate (wafer). In this embodiment, the imprint apparatus 100 adopts, as a resin (imprint material) curing method, a photo-curing method of curing a resin by ultraviolet irradiation. However, the present invention is not limited to this. The imprint apparatus 100 can also adopt, for example, a thermal curing method using a thermosetting resin.

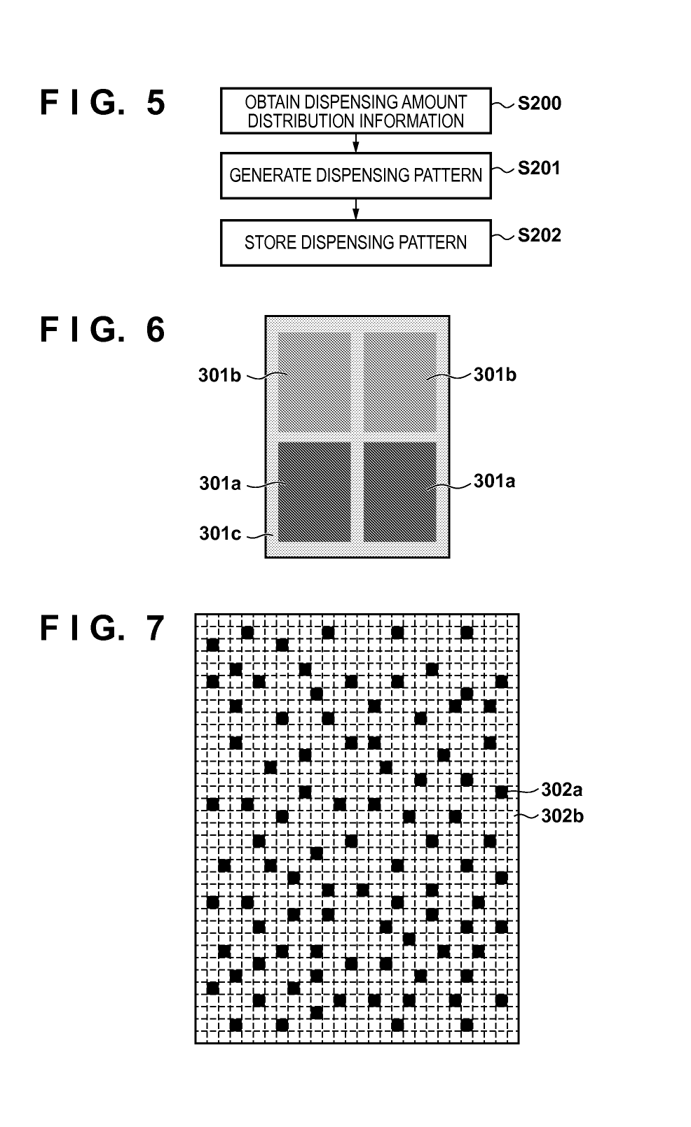

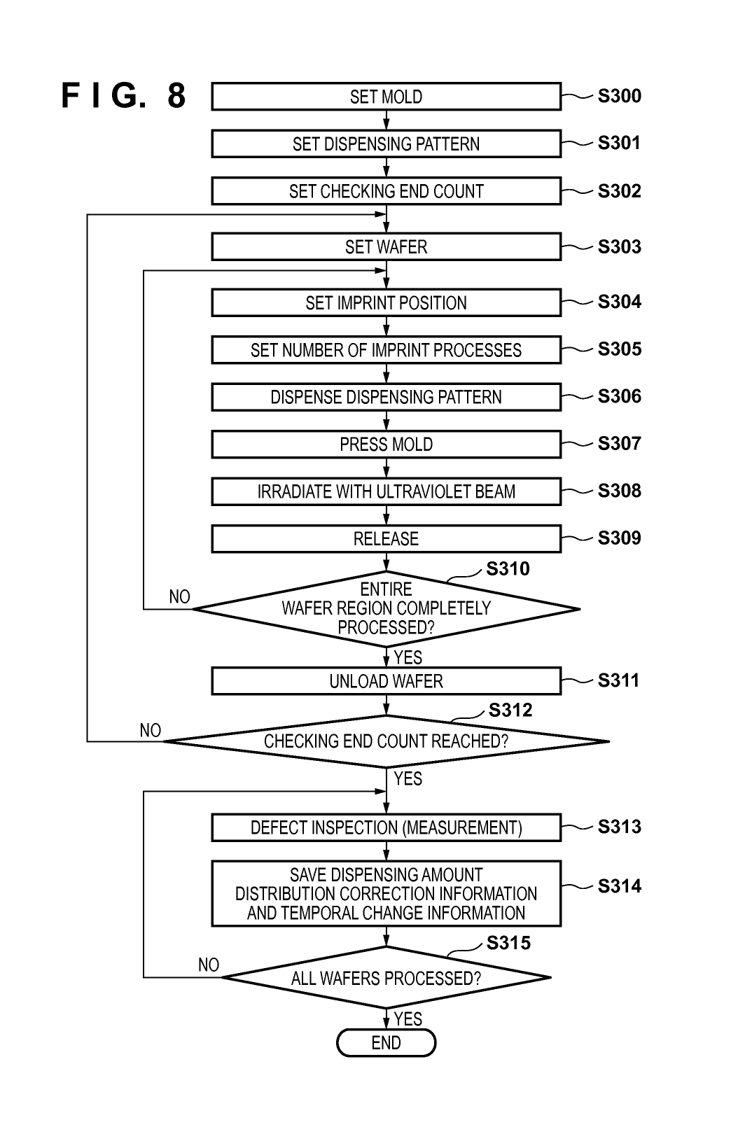

The imprint apparatus 100 includes a mold head 102 which holds a mold 101 (a die or an original), an ultraviolet irradiation unit 103, a stage 105 which holds a wafer 104, and a dispenser 110 serving as a coating unit which dispenses the resin. The imprint apparatus 100 further includes a resin supply unit 111, a controller (computer) 130, and a dispensing pattern storage unit 131. The dispensing pattern storage unit 131 is a storage unit which stores a plurality of resin dispensing patterns (supply pattern data of an imprint material) (to be described later) which corresponds to a number of imprint processes (information on time-dependent changes). A shape of the pattern portion 101a changes as the number of imprint processes comes up. In order to compensate a defect caused by the changes of the shape to form a desirable resin pattern, the dispensing pattern storage unit 131 stores resin dispensing patterns in accordance with the number of imprint processes. The dispensing pattern storage unit 131 is formed by, for example, a hard disk (a computer readable storage medium). The dispensing pattern storage unit 131 also stores programs related to a method for creating the dispensing pattern as illustrated in FIGS. 5 and 10, a control program related to the imprint process as illustrated in FIG. 8, and an ID of the mold (to be described later) and information associated with the ID. The mold 101 includes, on a surface facing the wafer 104, a pattern portion (concave portion) 101a in which a pattern that should be transferred to a resin 120 (imprint material) supplied onto the wafer 104 has been formed. In the pattern portion 101a, a three-dimensional pattern (groove) is formed. For example, the mold 101 has a rectangular outer shape and formed by a material (quartz or the like) that transmits an ultraviolet beam. The mold head 102 holds (fixes) the mold 101 by a vacuum suction force or an electrostatic force. The mold head 102 includes a driving mechanism which drives the mold 101 in the z-axis direction and presses the mold 101 against the uncured resin 120 dispensed on the wafer 104 by an appropriate force. After that, the ultraviolet irradiation unit 103 performs light irradiation to cure the resin 120, and then the mold 101 is peeled (released) from the cured resin on the wafer 104.

The wafer 104 is a substrate onto which the pattern of the mold 101 is transferred and includes, for example, a single-crystal silicon wafer or an SOI (Silicon on Insulator) wafer. The stage 105 includes a substrate chuck which holds the wafer 104, and a driving mechanism configured to perform alignment between the mold 101 and the wafer 104. For example, the driving mechanism is formed by a coarse driving system and a fine driving system, and drives the wafer 104 in the x-axis direction and the y-axis direction. The driving mechanism may have a function of driving the wafer 104 not only in the x-axis direction and the y-axis direction but also in the z-axis direction and the θ direction (rotational direction around the z-axis), and a tilt function of correcting the tilt of the wafer 104.

The resin supply unit 111 is a tank which stores an uncured resin and supplies it to the dispenser 110 by a pipe. This dispenser 110 is a mechanism which dispenses (supplies) the resin 120 and includes a plurality of orifices which unload, for example, the resin 120 onto the wafer 104. A unit of the dispensing amount (supply amount) of this dispenser 110 is a “drop”. The amount of the resin per drop is about several picoliters. A position in which the resin can be dropped has a width of several μms. The dispenser 110 dispenses the resin 120 by moving (scan moving or step moving) the stage 105 while supplying the resin 120 from the resin supply unit 111, thereby forming a resin layer on the wafer 104 (a shot region thereof).

The controller 130 includes a CPU and a memory, and controls the overall (operation of the) imprint apparatus 100. The controller 130 controls the respective units of the imprint apparatus 100 and functions as a processing unit which performs an imprint process. The controller 130 also functions as a generation unit which generates the resin dispensing pattern. The controller 130 performs, as the imprint process, the following process. First, the controller 130 sets a predetermined dispensing pattern selected by the storage unit 131 in the dispenser 110. After that, in a state in which the mold 101 is pressed against the resin 120 supplied onto the wafer 104, the controller 130 causes the ultraviolet irradiation unit 103 to perform ultraviolet irradiation for a predetermined time, thereby curing the resin. Then, the mold 101 is peeled from the cured resin, thereby transferring the pattern shape of the mold 101 onto the wafer 104.

(Details of Imprint Process)

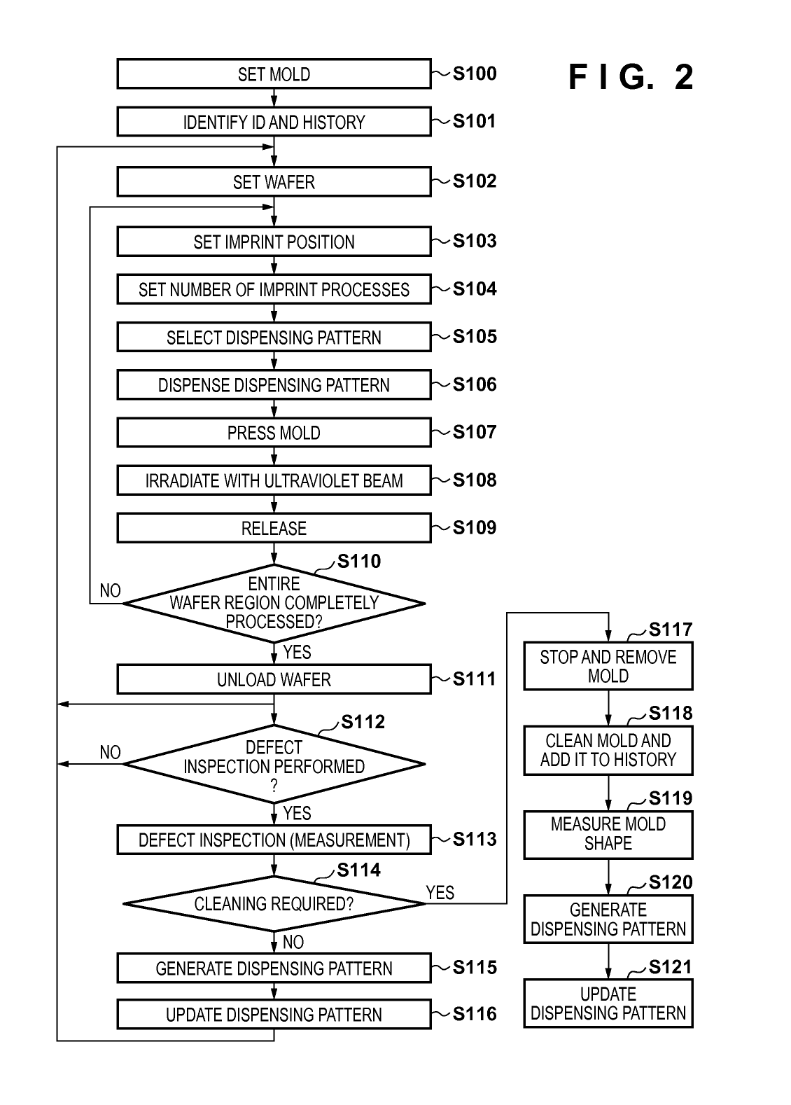

FIG. 2 is a flowchart showing a processing sequence when repeating pattern formation by imprinting. First, the mold 101 is prepared and mounted on the imprint apparatus 100. A plurality of molds having the same design data may be prepared and the detailed shape of the three-dimensional pattern varies individually. Furthermore, the three-dimensional pattern shape changes due to cleaning or the like.

In general, an ID is set for each mold. Information such as the type of pattern, measurement result information of the three-dimensional shape, and the history of maintenance such as cleaning is prepared separately in correspondence with this ID. This makes it possible to obtain the information by identifying the ID. Furthermore, it may be possible to identify molds having the pattern portions 101a formed in accordance with the same design data. As information to be prepared, necessary information other than the aforementioned information can be set as needed (step S100).

The controller 130 reads the ID of the mold 101, and identifies the type and the maintenance information of the mold 101 from a mold ID. The controller 130 obtains, based on this identification information, the pattern arrangement, the line width, the density, and the shape measurement result serving as design value information of the mold 101. The controller 130 further obtains, from the maintenance information, a history such as the number of cleaning operations or a cleaning condition and information shape change on a shape change by cleaning (step S101).

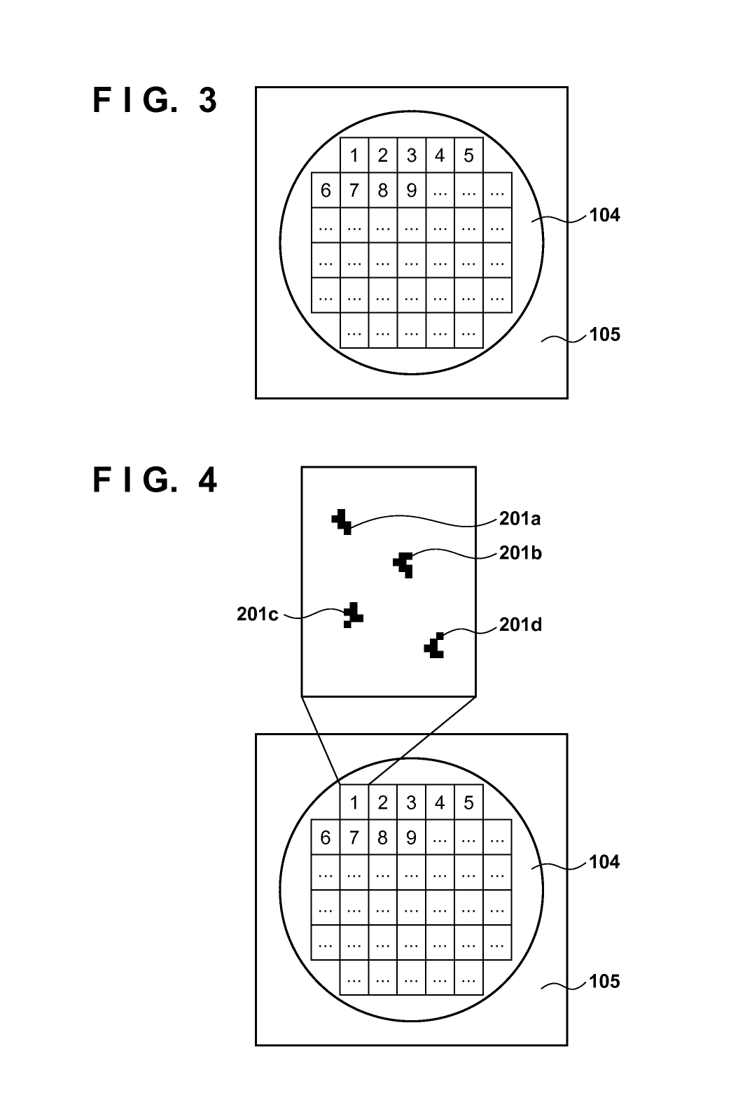

Next, the controller 130 mounts the wafer 104 on the stage 105 and fixes it by a substrate chuck mechanism (step S102). Then, the controller 130 designates, as an imprint position, a region where imprinting has not been performed yet (step S103). A region (processed region) where imprinting is performed at once is referred to as a “shot region”. As shown in, for example, FIG. 3, imprinting can be performed on the wafer 104 in order of continuous shot regions 1, 2, 3, 4, . . . . Imprint order is not limited to the aforementioned order, but can be set to, for example, zigzag order or random order.

Next, the controller 130 sets the number of imprint processes (step S104). One imprint process is defined as including pressing (imprinting) of one mold against one shot region, curing of the resin, and peeling (releasing) of the one mold. Note that “setting the number of imprint processes” means counting the accumulated number of imprint processes that have been performed on the same mold since the mold 101 was mounted and a first pattern was formed. Based on the set number of imprint processes and the shape change information obtained in step S101, the controller 130 selects the optimal dispensing pattern from the storage unit 131 and changes the dispensing pattern to be used. The changed dispensing pattern is set in the dispenser 110 (step S105). This dispensing pattern indicates the relationship between the dropping position (dispensing position) of the resin 120 and the dropping amount (dispensing amount) of the resin 120 onto the wafer. That is, the dispensing pattern is information indicating the supply amount distribution of the imprint material. A plurality of dispensing patterns are generated in advance based on the design value information such as the pattern arrangement, the line width, and the density of the mold 101 and the temporal change information including the number of imprint processes. Each dispensing pattern is optimized so as to allow imprinting without a defect and a film thickness abnormality. A method of obtaining the temporal change information such as shape degradation caused by the number of imprint processes and a method of generating the dispensing patterns based on the temporal change information are generated by a processing sequence shown in a flowchart of FIG. 10 to be described later.

Next, the photo-curing resin 120 are dispensed on the wafer 104 by using the dispenser 110. At this time, the dispenser 110 is selected in step S105 and, in accordance with a changed dispensing pattern, sequentially drops the resin 120 on the wafer 104 as the stage 105 moves (step S106).

After the resin 120 is dispensed on the wafer, the mold 101 is moved closer to the wafer 104 and waits for a predetermined time in a state in which it is brought into contact with (pressed against) the resin 120. This fills the three-dimensional shape of the mold 101 with the drop-shaped resin 120. The mold 101 is held in this state until the pattern of the mold 101 is filled with the resin. At first, filling with the resin 120 is not enough and a filling defect occurs in each corner of the pattern. However, as a holding time becomes longer, the resin 120 fills every corner of the pattern, decreasing the filling defects. A waiting time for filling (to be referred to as a filling time hereinafter) is shorter as the pattern is finer, and the longer filling time is needed for a coarse pattern such as a dummy pattern or mark (step S107).

Next, after the three-dimensional shape of the mold 101 is sufficiently filled with the resin, the resin 120 is irradiated with ultraviolet rays of the ultraviolet irradiation unit 103 from the back surface of the mold 101 for a predetermined time, thereby curing the resin 120. A halogen lamp, an LED or the like can be used as an ultraviolet light source (step S108).

Next, the mold 101 is peeled from the cured resin 120 by expanding the spacing between the mold 101 and the cured resin 120 (step S109). As a result, the pattern of the resin (to be referred to as a resin pattern hereinafter) cured in a state in which the shape of the pattern portion 101a is transferred is formed.

Next, it is determined whether pattern formation in the entire region on the wafer 104 has ended (step S110). If it is determined that pattern formation in the entire region has ended, the process advances to step S111. If it is determined that pattern formation in the entire region has not ended, the process returns to step S103 and is repeated, thereby forming the resin pattern obtained by transferring the pattern of the mold 101 onto the wafer 104.

Once resin pattern formation in the entire region has ended, the wafer is unloaded (step S111). The process returns to step S102 to imprint the next wafer.

Repeating the aforementioned process of steps S102 to S111 makes it possible to form the resin patterns on the plurality of wafers while exchanging them.

Furthermore, the controller 130 determines whether to perform a defect inspection of the unloaded wafer 104 (step S112). If the controller 130 determines to perform the defect inspection, the process advances to step S113. If the controller 130 determines not to perform the defect inspection, the process returns to step S102 to imprint the next wafer. The controller 130 determines whether to perform the defect inspection based on conditions like the number of imprint processes, the number of wafers where patterns have been formed in all the shot regions, and an elapsed time of the imprint process.

If the controller 130 determines to perform the defect inspection, the unloaded wafer is loaded into a wafer defect inspection apparatus to perform the defect inspection on the wafer (step S113). Then, defect information of the resin pattern formed in each shot region on the wafer 104 is detected. Here, a pattern defect inspection is performed using an optical defect inspection apparatus to detect a defect caused by a change in the mold 101. An unfilling defect may occur, for example, if a foreign substance such as the residual resin adheres to the mold 101, if there is a portion in which the resin 120 locally lacks, or if there is a shortage of a filling time. In addition to the unfilling defect, a defect such as adhesion of a particle onto the wafer or a void can also be detected. In this embodiment, an inspection condition and a classification condition are set so as to detect and extract an unfilling failure (a filling failure of the resin) based on, out of the detected defects, the adjustment of detection sensitivity and the periodicity (reproducibility) of the defects between the shot regions.

FIG. 4 is a view schematically showing an extracted result obtained by performing a defect inspection in the first shot region on the wafer 104. In FIG. 4, reference numerals 201a to 201d indicate defect portions.

Pattern defect detection using the optical defect inspection apparatus has been described as the example. However, the same defect detection can also be performed using another apparatus such as an electron beam defect inspection apparatus.

Referring back to FIG. 2, next, it is determined, based on unfilling defect information, whether cleaning of a mold pattern surface is necessary (step S114). More specifically, the defect information is information on the position coordinates of the unfilling defect and its defect size, and the number of defects. If it is determined that each of the defect size and the number of defects is larger than a reference value, the use of the mold in use is stopped and the process advances to cleaning step S117. If it is determined that each of the defect size and the number of defects is smaller than the reference value, the process advances to step S115. At this time, the reference value for determination can be set to an optimal value.

If it is determined that cleaning of the mold 101 is unnecessary, the defect information obtained in inspection step of S113 is fed back to the dispensing pattern that has been used before the defect inspection. That is, the dispensing pattern is updated based on the defect information (step S115). The controller 130 predicts locally lacking resin dispensing amount, and generates a new dispensing pattern based on new corrected dispensing amount distribution information. More specifically, the controller 130 increases the resin to be dispensed in proximity to the defect portions or corrects the arrangement position of the droplets arranged in proximity to the defect portions to approach the defect portions.

Next, a plurality of newly generated dispensing patterns are registered in the storage unit 131. Furthermore, another dispensing pattern stored in the storage unit 131 and regenerated in accordance with the number of imprint processes is also generated based on the defect information obtained in step S113 to update the dispensing pattern in the storage unit 131 (step S116). After that, the imprint process continues with the updated dispensing pattern when repeating steps S102 to S111. If the imprint processes in steps S102 to S111 are also continued while performing steps from step S112, the used dispensing pattern may be updated to the newly generated dispensing patterns at a timing when the wafer 104 different from the wafer used for the defect inspection is unloaded.

If it is determined in step S114 that cleaning of the mold 101 is necessary, the process advances to step S117. The imprint process is stopped to remove the mold 101 (step S117). The removed mold is loaded into a cleaning apparatus to be cleaned (step S118). The cleaning apparatus performs cleaning by appropriately combining wet-cleaning of cleaning, for example, dust or contamination adhered to the mold by using chemical solution, pure water, or the like and dry-cleaning of cleaning it by using excimer UV, an atmospheric-pressure plasma, or the like. After cleaning, cleaning history information such as the number of cleaning operations and a cleaning method is updated for the ID of the mold 101.

Next, the three-dimensional shape of the pattern portion 101a of the cleaned mold is measured (step S119). The three-dimensional shape is described by, for example, the CD (Critical Dimension), the Duty Cycle (the volume ratio of the concave portion and the convex portion), the depth of the concave portion (the height of the convex portion), the taper angle of the three-dimensional portion, and surface roughness (Ra). A physical quantity indicating such three-dimensional shape can be measured by using, for example, a general dimensional measurement apparatus, height measurement apparatus, and roughness measurement apparatus. More specifically, an electron beam dimensional measurement apparatus (CD-SEM) is used to perform CD measurement and Duty Cycle measurement. For example, the dimension of the three-dimensional shape formed by a repetitive pattern of a line portion and a space portion is measured to measure the widths of the line portion and the space portion. Measurement is performed on a plurality of portions and dimensional measurement information is saved. The Duty Cycle can be calculated from the ratio of the line portion and the space portion. The depth of the concave portion, the taper angle of the three-dimensional portion, and surface roughness are measured by an AFM or a confocal microscope. It is also possible to measure the pattern portion (concave portion) 101a directly or to measure a measurement pattern provided around the pattern portion (concave portion) 101a.

If the mold pattern surface (the surface on a side facing the wafer) is cleaned, in addition to the fact that the surface of the mold pattern surface is worn and becomes thinner, a distribution also occurs in the wear amount in accordance with the three-dimensional shape. By cleaning a repetitive three-dimensional pattern of the line portion and the space portion formed on the mold pattern surface, the width of the convex portion becomes smaller and width of the concave portion becomes larger. Accordingly, the volume ratio of the concave portion increases. If the top of the convex portion is further worn, the height of the convex portion (the depth of the concave portion) becomes smaller and the taper angle of the three-dimensional portion becomes smaller. If the three-dimensional shape of the surface becomes smaller, surface roughness changes in a direction to be smaller. The physical quantity indicating the above-described three-dimensional shape can be obtained by measuring the mold pattern surface directly or by measuring the three-dimensional shape of the resin obtained by test imprinting after cleaning. When measuring the three-dimensional shape of the resin obtained by test imprinting, it is also possible to form the section of the resin and measure the three-dimensional shape.

Next, a dispensing pattern capable of correcting an unfilling defect caused by wearing the pattern due to cleaning is generated based on shape information obtained by measurement (step S120). Other dispensing patterns are also generated in accordance with the number of imprint processes. These plurality of newly generated dispensing patterns are registered in the storage unit 131 (step S121). A dispensing pattern may be generated by using, instead of the shape information of the pattern portion 101a obtained by measurement, the difference between the shape information of the initial pattern portion 101a and the dimensional measurement information before cleaning the mold 101.

If imprinting is restarted using the cleaned mold 101 again, the process returns to step S100, and the imprint process continues with the cleaned mold and dispensing pattern.

(Method of Generating Dispensing Pattern)

A method of generating a plurality of dispensing patterns corresponding to the number of imprint processes by the controller 130 prior to the imprint process will be described with reference to FIGS. 5 to 10. First, a dispensing pattern corresponding to an unused mold is generated. FIG. 5 is a flowchart showing a process of generating the dispensing pattern. The controller 130 obtains dispensing amount distribution information obtained by calculating a dispensing amount required for each region from the design value information of the mold 101 (step S200). A dispensing amount distribution is calculated based on, for example, the position and the depth of the three-dimensional pattern in each region on the mold. Note that the dispensing amount distribution is converted into image data represented by grayscale multi-value information, and is used as the dispensing amount distribution information. FIG. 6 is a view schematically showing the obtained dispensing amount distribution information. In FIG. 6, reference numerals 301a to 301c indicate grayscale information calculated from a pattern density. Reference numeral 301a indicates a region where the three-dimensional density of the pattern is high, reference numeral 301b indicates a region where the three-dimensional density of the pattern is medium, and reference numeral 301c indicates a region where the three-dimensional density of the pattern is low.

Next, the controller 130 binarizes multi-value data of the dispensing amount distribution information by halftone processing. The data converted into binary information of discharge and non-discharge of the droplet is generated as a dispensing pattern (step S201). Note that a known error diffusion method can be used as halftone processing. A description of the error diffusion method will be omitted. FIG. 7 is a view schematically showing the generated dispensing pattern. In FIG. 7, each black pixel 302a indicates information on discharge of the resin (the position to which the imprint material is supplied) and each white pixel 302b indicates information on non-discharge of the resin (the position to which no imprint material is supplied). The controller 130 stores the generated dispensing pattern in the storage unit 131, thereby terminating dispensing pattern formation (step S202).

In this embodiment, the data converted into binary information of discharge and non-discharge of the resin is used as the dispensing pattern. However, a data format is not limited to this. Numerical value data which represents the dispensing position of each resin by relative position coordinates within a dispensing area can also be used. Drop amount information of each resin can also be added for use.

(Method of Obtaining Temporal Change Information)

A method of obtaining temporal change information on, for example, degradation in the three-dimensional shape of the pattern on the mold 101 required to generate the dispensing pattern corresponding to the number of imprint processes will now be described. FIG. 8 is a flowchart showing an obtaining process of a temporal change. First, the mold 101 to be used is mounted on the imprint apparatus 100 (step S300). Next, the controller 130 sets, in the dispenser 110, a dispensing pattern generated in accordance with a processing sequence shown in FIG. 5 (step S301). Then, the controller 130 sets the number of imprint processes of checking the temporal change in the mold 101 (checking termination count) (step S302). For example, the number can be set to 1,000 (the common multiple of the number of shot regions per wafer and the number of wafers). After that, the wafer 104 is mounted and fixed on the stage 105 (step S303). The processes in steps S304 to S311 are the same as in the aforementioned processes in steps S103 to S111, and thus a description thereof will be omitted.

Next, the controller 130 determines whether the number of imprint processes has reached (exceeded) the checking end count (step S312). If the controller 130 determines that the number of imprint processes has reached the checking end count, the process advances to step S313. If the controller 130 determines that the number of imprint processes has not reached the checking end count, the processes in steps S303 to S312 are repeated.

In step S313, the unloaded wafer 104 is loaded into the wafer defect inspection apparatus to perform the defect inspection on the wafer 104. As in step S114, the defect information is information on the position coordinates of the defect and its defect size, and the number of defects. All the imprinted shot regions undergo the defect inspection. The inspecting positions are not limited to all the shot regions. It is also possible to set the positions such that the inspection is performed on an arbitrary shot region within the wafer 104 in consideration of a measurement time, defect occurrence frequency, or the like.

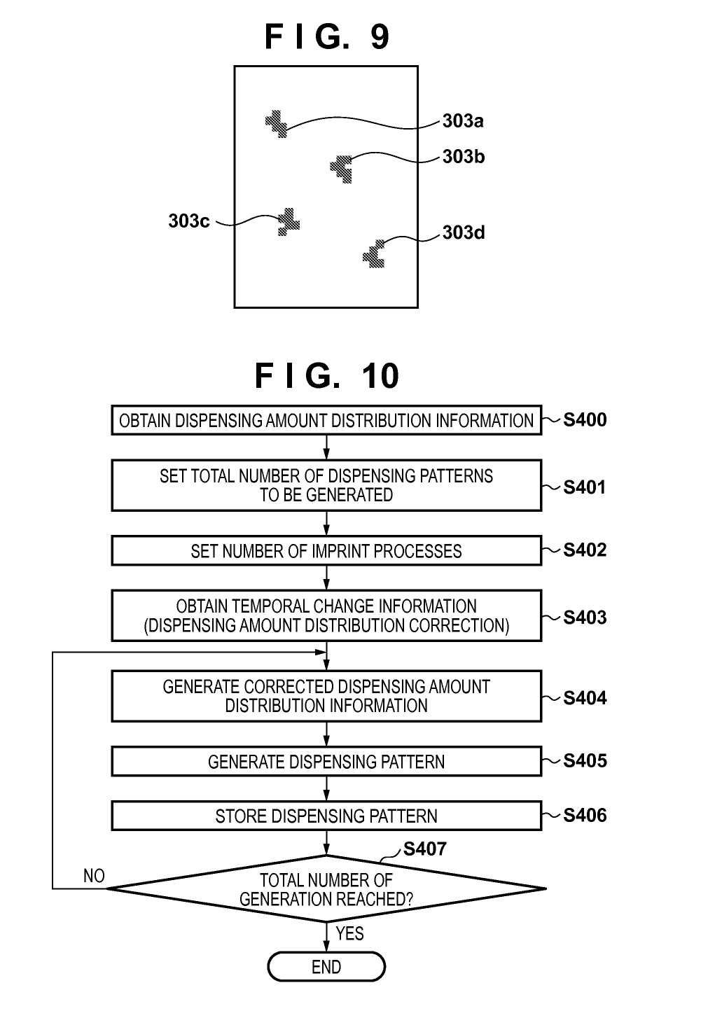

Based on the detected defect information, information obtained by calculating a dispensing amount distribution capable of predicting the locally lacking resin dispensing amount and increasing the droplets of the resin in proximity to the defect portions is saved as correction information (step S314). The dispensing amount distribution information is calculated, by using the correction information and design value information of the mold 101, in the same method as in step S200 described above. FIG. 9 is a view schematically showing the correction information. Each of reference numerals 303a to 303d in FIG. 9 indicates a region where a defect occurs and a dispensing amount is desirably increased locally by correction, and its increase ratio in concentrations. All reference numerals 303a to 303d have the same ratio.

The controller 130 saves, as temporal change information, the number of imprint processes and the aforementioned correction information in the storage unit 131. However, the temporal change information is not limited to these. Information including information for reflecting, to the dispensing pattern, the temporal change such as the defect information like the defect position coordinates or the number of defects, or a value obtained by calculating a coefficient for correcting the total amount of the dispensing amount, or information obtained by converting the information into multi-value image data may be used.

Next, it is determined whether the process has ended with respect to all the imprinted wafers 104 (step S315). If it is determined that the process has ended, obtainment of the temporal change information ends. If it is determined that the process has not ended, the process returns to step S313 to change to the next wafer 104 and continue obtainment of the temporal change information.

In this embodiment, information obtained by measuring the position coordinates of the defect and its defect size, and the number of defects is used as the defect information. However, the present invention is not limited to this. It is also possible to, for example, calculate correction information from the film thickness distribution obtained by measuring the film thickness of the formed resin pattern.

(Method of Generating Dispensing Pattern Based on Temporal Change Information)

A process of generating, based on the obtained temporal change information, a dispensing pattern corresponding to the number of imprint processes will now be described. FIG. 10 is a flowchart showing a process of generating a plurality of dispensing patterns based on the temporal change information. The controller 130 obtains the dispensing amount distribution information of the mold 101, as in step S200 described above (step S400). Next, the controller 130 sets the total number of dispensing patterns to be generated (step S401). Then, the controller 130 sets the number of imprint processes for the dispensing patterns to be generated (step S402). The controller 130 obtains, from the prepared temporal change information (for example, information generated by repeating steps S300 to S315), the correction information out of the temporal change information of the set number of imprint processes (step S403).

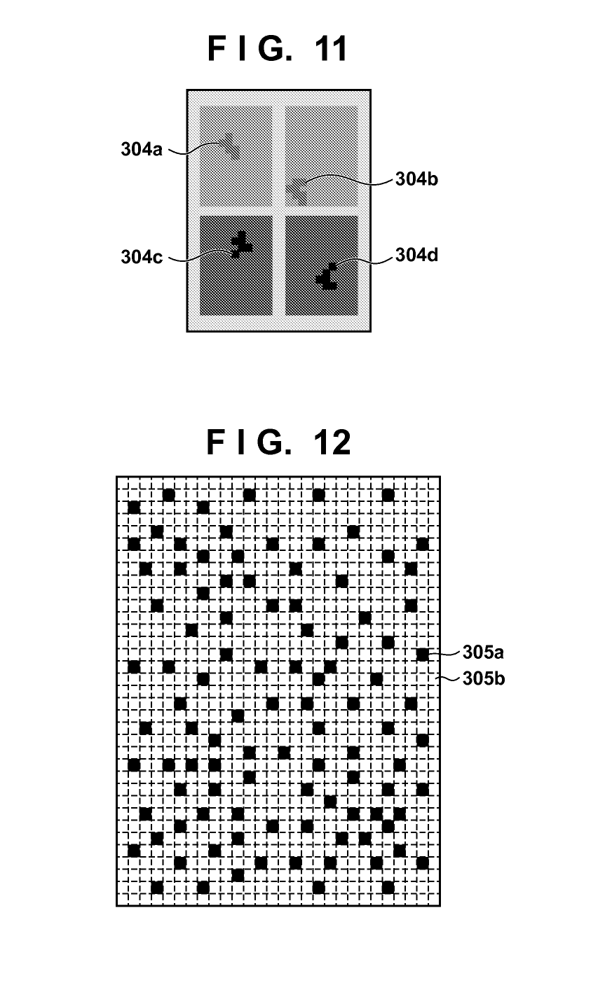

Corrected dispensing amount distribution information is generated by adding the dispensing amount distribution information of the mold 101 obtained in step S400 and the correction information obtained in step S403 (step S404). FIG. 11 is a view schematically showing the corrected dispensing amount distribution information. Each of reference numerals 304a to 304d in FIG. 11 indicates a portion where a dispensing amount increases locally with respect to the dispensing amount distribution information of the mold 101.

Next, the controller 130 generates, as in step S201, a dispensing pattern by binarizing multi-value data of the corrected dispensing amount distribution information (step S405). FIG. 12 is a view schematically showing the generated dispensing pattern. In FIG. 12, each black pixel 305a indicates information on discharge of the droplet and each white pixel 305b indicates information on non-discharge of the droplet. As seen in FIG. 12, the number of droplets in the portions indicated by reference numerals 304a to 304d of FIG. 11 increases, and in addition, their positions are changed.

Referring back to FIG. 11, the controller 130 stores, as in step S202, the generated dispensing pattern in the storage unit 131 (step S406). At this time, the controller 130 stores, in the storage unit 131, the number of imprint processes and the generated dispensing pattern in association with each other.

Next, the controller 130 determines whether the total number of generated dispensing patterns has reached the number set in step S401 (step S407). If the controller 130 determines that the total number has not reached the set number, the process advances to step S402. If the controller 130 determines that the total number has reached the set number, the process ends.

As described above, according to the first embodiment, a resin pattern is formed by using the dispensing pattern corresponding to the number of imprint processes. This makes it possible to suppress occurrence of the defects and the film thickness abnormalities of the resin pattern caused by shape degradation in the pattern portion 101a caused by repeating the imprint processes and shape degradation in the pattern portion 101a caused by cleaning the mold 101. Furthermore, according to the first embodiment, a dispending pattern to be used after the number of imprint processes exceeds a predetermined number of times is updated based on a defect measurement result of the resin pattern or the shape change in the cleaned pattern portion 101a. Hence, it is possible to further suppress a defect and a film thickness abnormality of a resin pattern formed on the wafer.

### Second Embodiment

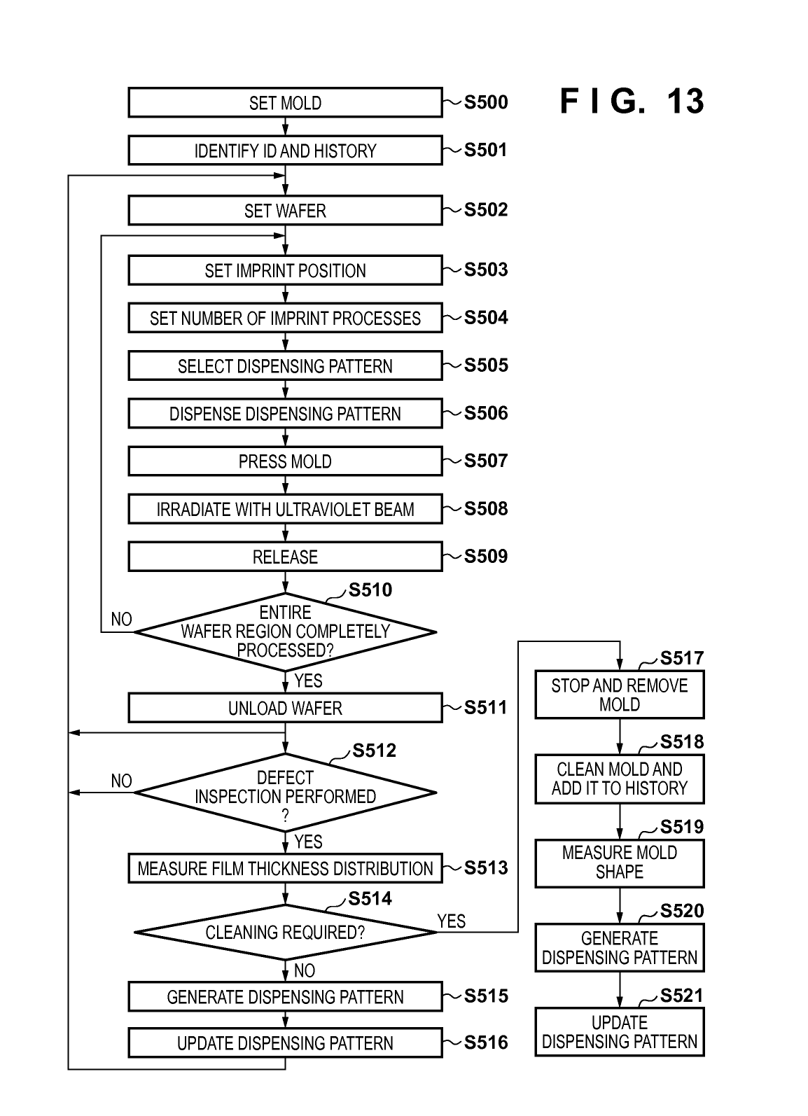

An embodiment in which a dispensing pattern is updated based on, as defect information, defect information serving as the measurement result of a film thickness distribution of a resin pattern will now be described as the second embodiment. An imprint apparatus used in the second embodiment is the same as in the first embodiment except that a storage unit 131 stores a program related to an imprint process and shown in a flowchart of FIG. 13. In addition, the same method as in the first embodiment is used for a method of generating the dispensing pattern.

(Description of Imprint Process)

FIG. 13 shows a processing sequence when repeating pattern formation by imprinting. In steps S500 to S512, imprinting is performed as in steps S100 to S112 of the first embodiment. The method is the same as in the first embodiment, and thus a description thereof will be omitted.

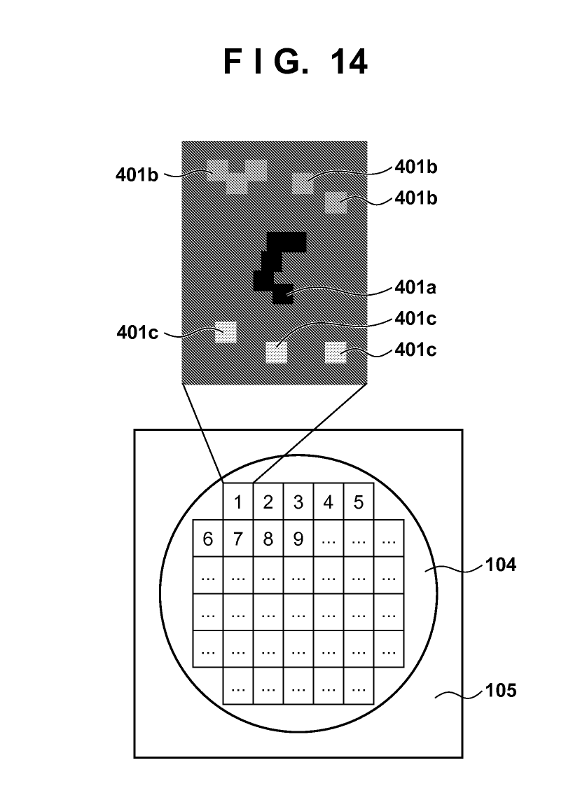

If performing a defect inspection, an unloaded wafer is loaded into a film thickness measurement apparatus to perform the defect inspection on the wafer. Film thickness measurement is performed using an optical film thickness measurement apparatus, thereby detecting a film thickness abnormality from a film thickness distribution (step S513). The film thickness abnormality of a resin pattern formed in each shot region of a wafer 104 is detected. FIG. 14 is a view schematically showing a film thickness distribution result obtained by performing film thickness measurement in the first shot region on the wafer 104. Reference numerals 401a to 401c indicate film thickness abnormal portions. Reference numeral 401a indicates the portion having a thick film thickness, reference numeral 401b indicates the portion having a slightly thinner film thickness than the film thickness abnormal portion 401a, and reference numeral 401c indicates the portion having a further thinner film thickness than the film thickness abnormal portion 401b. An optical film thickness inspection apparatus is used here. However, the same film thickness inspection can also be performed by another apparatus such as a contact type film thickness inspection apparatus.

Next, it is determined whether cleaning of a mold 101 is necessary (step S514). The measured film thickness distribution information is used here. More specifically, information on the magnitude, size, and position of the film thickness relative to a reference film thickness is used. If it is determined that they are larger than reference values, the use of the mold 101 in use is stopped and the process advances to a cleaning step in step S517. If it is determined that they are smaller than the reference values, the process advances to step S515. At this time, the reference values of determination can be set to optimal values.

If it is determined that cleaning of a mold 101 is unnecessary, the detected defect information is fed back to the dispensing pattern of resin 120. Locally sufficient or insufficient resin dispensing amounts are predicted based on the measured film thickness distribution information, and a resin dispensing pattern is generated based on a new correction dispensing amount distribution information (step S515). A plurality of dispensing patterns corresponding to the number of imprint processes are generated based on a newly set resin dispensing amount and temporal change information by the number of imprint processes. A method of generating the dispensing patterns based on the temporal change information by the number of imprint processes are generated by the aforementioned processing sequence.

After that, imprinting is performed in the same manner as in steps S116 to S121 of the first embodiment until steps S516 to S521. The method is the same as in the first embodiment, and thus a description thereof will be omitted.

(Another Example of Method of Obtaining Temporal Change Information)

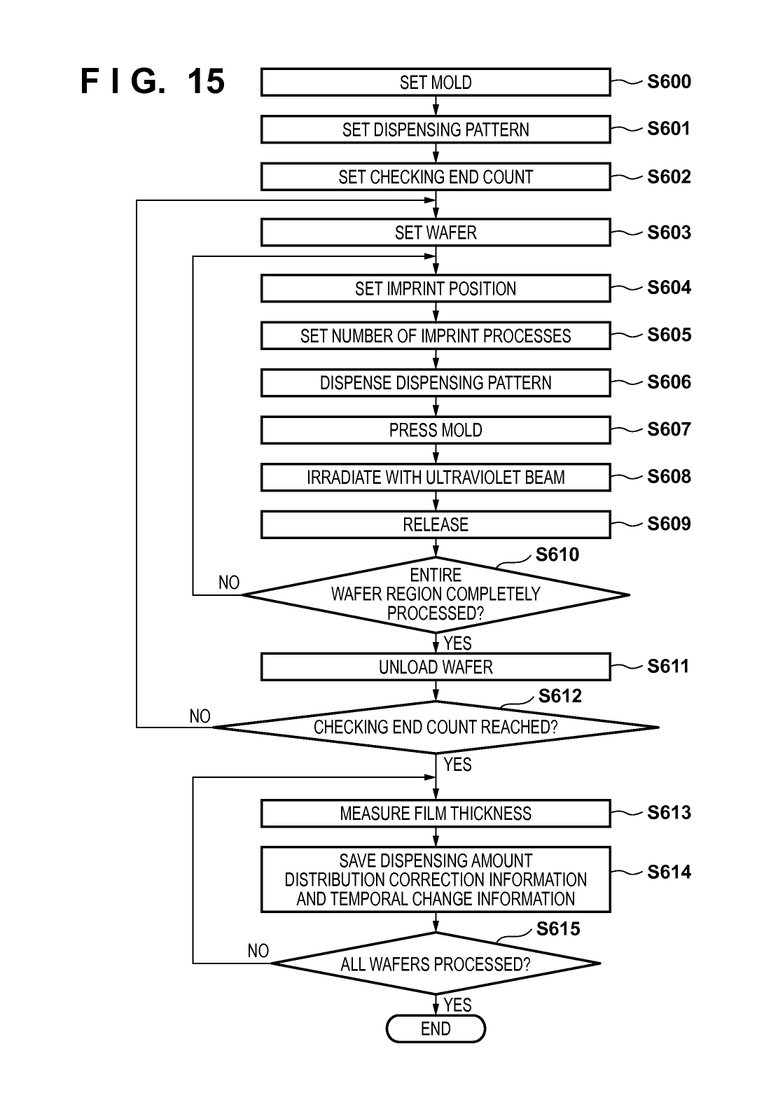

Another example of a method of obtaining the temporal change experimentally will now be described. FIG. 15 is a flowchart showing another example of the method of obtaining the temporal change. Imprinting is performed in the same manner as in steps S300 to S312 of the first embodiment until steps S600 to S612. The method is the same as in the first embodiment, and thus a description thereof will be omitted.

The unloaded wafer is loaded into the film thickness measurement apparatus to perform a defect inspection on the wafer (step S613). In this embodiment, film thickness measurement is performed using the optical film thickness measurement apparatus, thereby detecting the film thickness abnormality from the film thickness distribution. All the shot regions are inspected as defect inspecting positions in the imprinting order. The inspecting positions are not limited to all the shot regions. It is also possible to set such that the inspection is performed on an arbitrary shot region within the wafer in consideration of a measurement time, defect occurrence frequency, or the like.

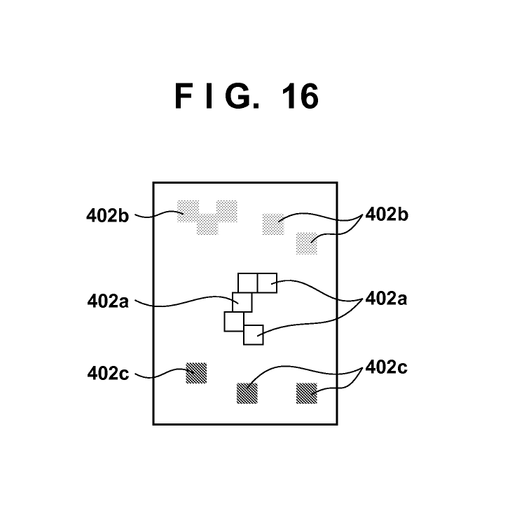

Based on the detected defect information, a controller 130 saves, as correction information, information obtained by calculating a dispensing amount distribution capable of predicting the locally lacking resin dispensing amount and increasing resin droplets in proximity to the defect portions (step S614). Dispensing amount distribution information is calculated by the same method as in step S200 described above by using the correction information and design value information of the mold 101. FIG. 16 is a view schematically showing the correction information in the certain number of imprint processes. Each of reference numerals 402a to 402c in FIG. 16 indicates a region where the film thickness abnormality occurs and a dispensing amount is desirably increased or decreased locally by correction, and an increase or decrease ratio in concentrations. Each reference numeral 402a indicates a portion where a reduction in the dispensing amount is desired, each reference numeral 402b indicates a portion where a slight increase in the dispensing amount is desired, and each reference numeral 402c indicates a portion where a further increase in the dispensing amount is desired as compared with the portion 402b. The increase or decrease ratio of each region is −5% for each reference numeral 402a, +5% for each reference numeral 402b, and +15% for each reference numeral 402c. The controller 130 further saves the number of imprint processes and the aforementioned correction information.

Next, it is determined whether the process has ended with respect to all the imprinted wafers 104 (step S615). If it is determined that the process has ended, obtainment of the temporal change information ends. If it is determined that the process has not ended, the process returns to step S613 to change to the next wafer and continue obtainment of the temporal change information.

### Third Embodiment

### Method of Updating Dispensing Pattern Based Only on Shape Change in Mold Before and after Cleaning

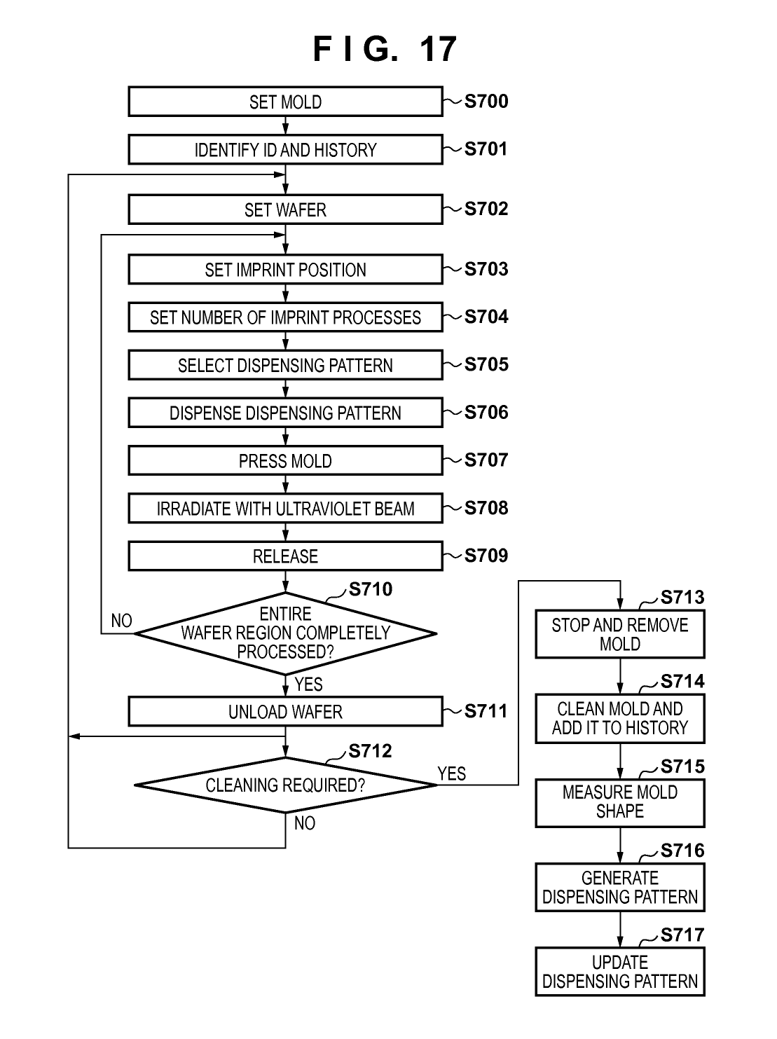

A method of generating a dispensing pattern and repeating imprint processes only by temporal change information will now be described as the third embodiment. An imprint apparatus, a method of obtaining the temporal change information, and a method of generating the dispensing pattern used in this embodiment are the same as in the first embodiment except that the storage unit 131 stores a program related to an imprint process and shown in a flowchart of FIG. 17.

(Description of Imprint Process)

FIG. 17 shows a processing sequence when repeating pattern formation by imprinting according to the third embodiment. Imprinting is performed in the same manner as in steps S100 to S111 of the first embodiment until steps S700 to S711. The method is the same as in the first embodiment, and thus a description thereof will be omitted.

Next, it is determined whether cleaning of a mold 101 is necessary (step S712). Determination is made here based on whether the number of imprint processes has reached a predetermined number (for example, 2,000). If it is determined that cleaning is unnecessary, the process returns to step S702 to continue imprinting. If it is determined that cleaning is necessary, the process advances to step S713 and returns to step S702. The number of imprint processes can be set by obtaining, by an experiment, the number of imprint processes by which a temporal change by imprinting causes no defect. In addition to the number of imprint processes, a determination criterion of whether to perform cleaning can be set arbitrarily.

After that, the processes in steps S713 to S717, performed if it is determined that cleaning of a mold 101 is necessary, are performed in the same manner as in steps S117 to S121 of the first embodiment. The method is the same as in the first embodiment, and thus a description thereof will be omitted. The same effect as in the first and second embodiments can also be obtained in the above third embodiment.

### Fourth Embodiment

### Method of Continuing Imprinting Only by Updating Dispensing Pattern Based Only on Defect Inspection Result

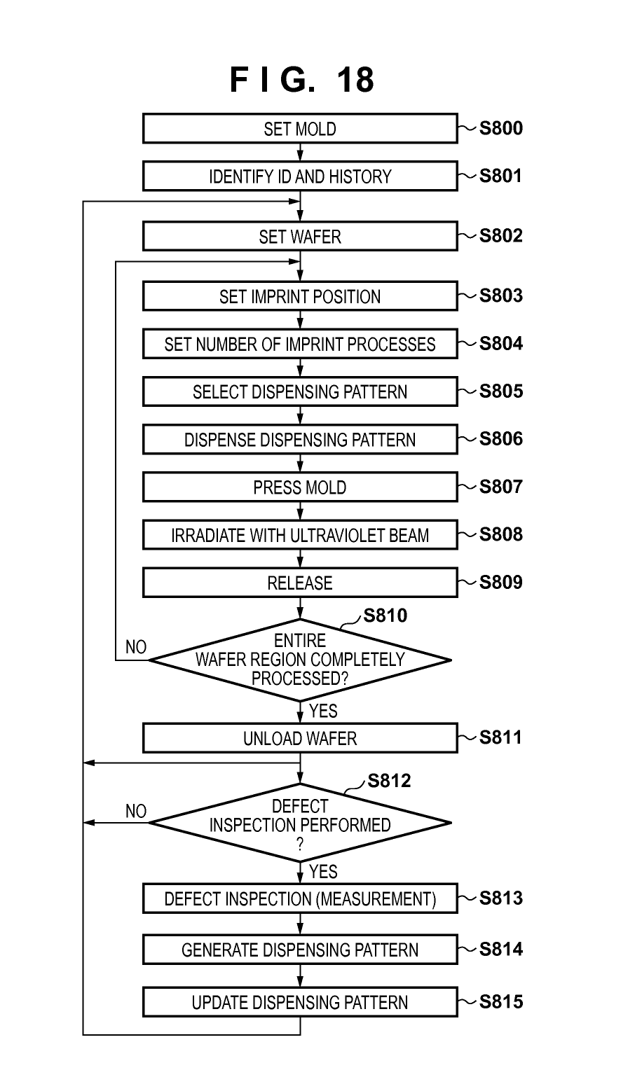

A method of repeating imprint processes while selecting a dispensing pattern corresponding to the number of imprint processes and updating a dispensing pattern in a storage unit 131 based on a defect inspection result will now be described as the fourth embodiment. An imprint apparatus, a method of obtaining temporal change information, and a method of generating the dispensing pattern used in the fourth embodiment are the same as in the first embodiment except that the storage unit 131 stores a program related to the imprint process and shown in a flowchart of FIG. 18.

(Description of Imprint Process)

FIG. 18 shows a processing sequence in a case in which the imprint process is repeated according to the fourth embodiment. Imprinting in steps S800 to S811 is performed in the same manner as in steps S100 to S111 of the first embodiment. The method is the same as in the first embodiment, and thus a description thereof will be omitted.

Next, it is determined whether to perform the defect inspection on an unloaded wafer 104 (step S812). If it is determined to perform the defect inspection, the process advances to step S813. If it is determined not to perform the defect inspection, the process returns to step S802 to imprint a next wafer. Determination is made here based on whether the number of imprint processes has reached (exceeded) a predetermined number (for example, 1,000). As in other embodiments, conditions like the number of imprint processes, the number of wafers having patterns formed in their entire surfaces, and an elapsed time can be set as the criteria of determining whether to perform a defect inspection.

If it is determined to perform the defect inspection, the unloaded wafer 104 is loaded into a wafer defect inspection apparatus to perform the defect inspection on the wafer 104 by the same method as in the first embodiment (step S813). Next, the detected defect information is fed back to the resin dispensing pattern. Based on the defect information, the controller 130 predicts locally lacking resin dispensing amount and generates a dispensing pattern based on new correction dispensing amount distribution information (step S814). The controller 130 generates a plurality of dispensing patterns corresponding to the number of imprint processes in the same manner based on another newly set resin dispensing amount and temporal change information obtained by the number of imprint processes. Then, the plurality of generated dispensing patterns are stored and updated in a storage unit 131 (step S815). After that, imprinting is continued in steps S802 to S811 with a new dispensing pattern.

As described above, the same effect as in the first to third embodiments can also be obtained in the fourth embodiment.

### Fifth Embodiment

### Method of Continuing Imprinting by Using Dispensing Pattern Corresponding to Shape Change in Mold by Cleaning

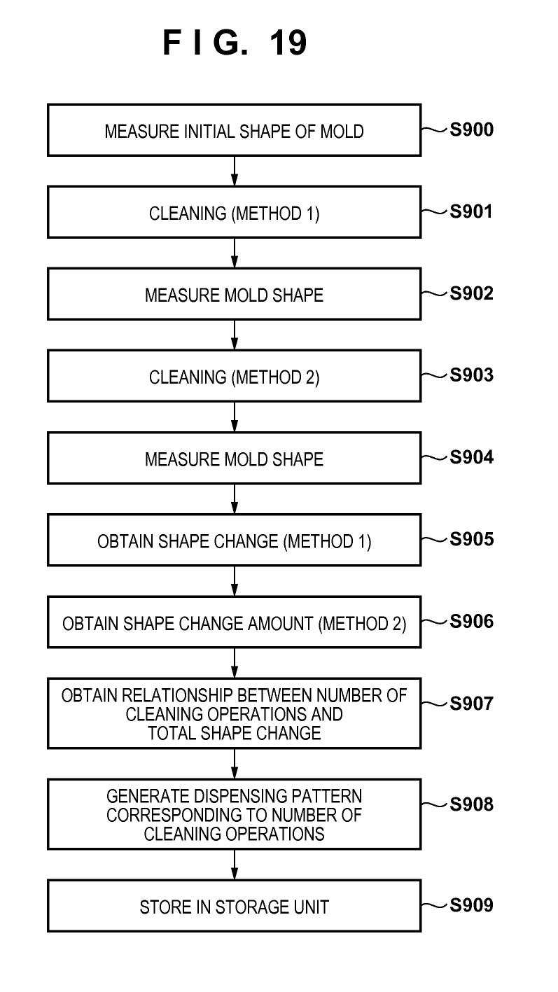

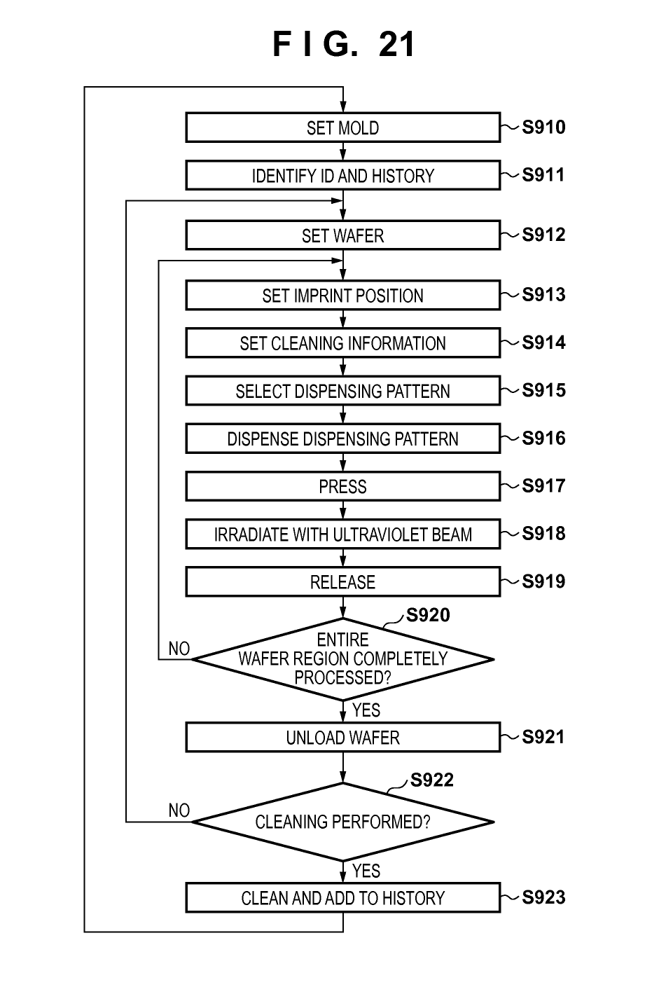

In the fifth embodiment, an imprint method of forming a pattern by selecting, from a plurality of dispensing patterns prestored in a storage unit 131, a dispensing pattern corresponding to the number of cleaning operations and a cleaning method will be described. The storage unit 131 stores the dispensing pattern corresponding to the number of cleaning operations and the cleaning method, a program related to a method of generating the dispensing pattern shown in a flowchart of FIG. 19, and a program related to an imprint process shown in a flowchart of FIG. 21. An imprint apparatus used in this embodiment is the same as in the first embodiment in other aspects.

As the number of imprint processes increases, a defect occurs in a pattern that can be formed if a resin is deposited in the concave portion of a mold pattern. While the deposited resin or a foreign substance can be removed by cleaning a mold, the mold pattern may be worn (deformed) by cleaning. If a mold with a large shape change continues to be used, the concave portion of the mold pattern is not filled with the resin in the manner as described above, becoming a factor in causing an unfilling defect. Beforehand, a shape change in a mold pattern portion (information concerning of the shape change in the mold) correlated to the number of cleaning operations and the cleaning method is measured, and a dispensing pattern is generated by using the measurement result. Occurrence of defect patterns is reduced by updating, in accordance with the timing of the imprint process, a dispensing pattern to be used.

(Method of Generating Dispensing Pattern)

A method of generating a plurality of dispensing patterns to be stored in the storage unit 131, and corresponding to the number of cleaning operations and the cleaning method will be described. Note that the cleaning operation from a time when pattern formation is temporarily suspended and the mold 101 is demounted from a mold head till the mold 101 is cleaned and mounted on a mold chuck again is counted as one time. One cleaning method may combine cleaning steps on various conditions.

For the sake of simplicity, a method of generating the dispensing pattern in a case in which imprinting is continued while performing cleaning, per cleaning operation, in either a “method 1” or a “method 2” will be described in this embodiment. The “method 1” and the “method 2” are the names of the cleaning method. In the method 1, only dry-cleaning is performed. In the method 2, a dry-cleaning step and a wet-cleaning step are performed in combination each time.

Dry-cleaning is a method of cleaning dust or contamination adhered to the mold 101 by using excimer UV, an atmospheric-pressure plasma or the like. Wet-cleaning is a method of cleaning dust or a residual resin adhered to the mold 101 by discharging pure water or an acid chemical, an alkaline chemical, or the like to a mold pattern portion.

The contents of the cleaning method in the respective cleaning operations are determined for each type of mold 101, and that information is recorded in a mold ID. The mold pattern portion is basically cleaned by the cleaning method of the method 1, and is cleaned, every three times, by the method 2 having a larger cleaning force (larger shape change) than the method 1.

FIG. 19 is a flowchart showing the method of generating the dispensing pattern. A user performs steps S901 to S904. In steps S905 to S909, a step of generating, by a controller 130, a dispensing pattern based on a measurement result is shown.

First, the user measures the shape (three-dimensional shape) of the mold pattern portion by using a CD-SEM or the like (step S900). Next, the user cleans the mold 101 by the method 1 using a cleaning apparatus (step S901). Next, the user measures, by using the CD-SEM or the like, the shape of the mold pattern portion again (step S902). Next, the user cleans the mold 101 by the method 2 using the cleaning apparatus (step S903). Next, the user measures, by using the CD-SEM or the like, the shape of the mold pattern portion again (step S904).

The controller 130 obtains the measurement results in steps S900 and S902 and obtains, from the measurement results, the shape change in the mold 101 per cleaning operation by the method 1 (step S905). The shape change to be obtained includes, for example, a change in information such as the CD (Critical Dimension), the Duty Cycle (the volume ratio of the concave portion and the convex portion), the depth of the concave portion (the height of the convex portion), the taper angle of the three-dimensional portion, and surface roughness (Ra). The controller 130 obtains the measurement results in steps S902 and S904 and obtains, from the measurement results, the shape change in the mold 101 per cleaning operation by the method 2 (step S906).

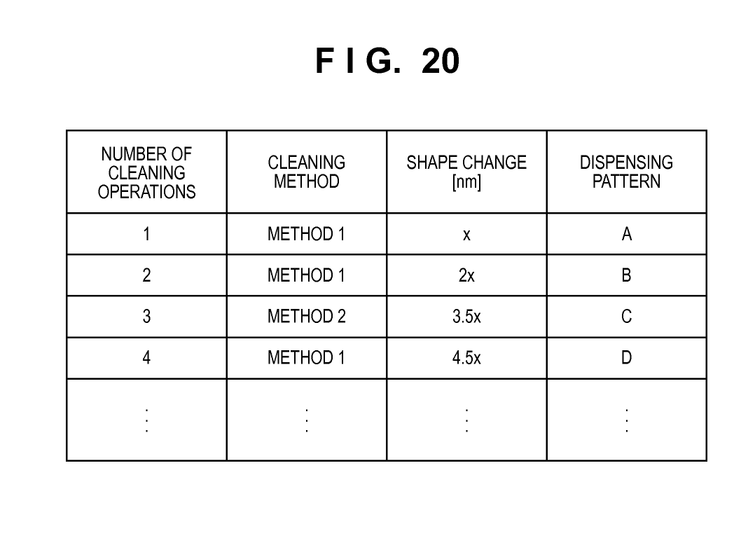

Next, the controller 130 obtains a total shape change (accumulated deformation amount) corresponding to the number of mold cleaning operations (step S907). The total shape change refers to a change amount of the mold shape measured in step S900. A change in the depth of the concave portion will only be described below. Another change in information concerning of the mold shape may be quantified. Assuming that the shape change obtained in step S905 is x [nm] and that in step S906 is 1.5x [nm], the shape change for each number of cleaning operations is as shown in FIG. 20. Since the first-time cleaning method is the method 1, the shape change is x [nm]. If cleaning is performed once more by the method 1, the shape change will be 2x [nm]. Since the third-time cleaning method is the method 2, the total shape change when the third-time cleaning operation has finished is 3.5x [nm]. The total shape change in the mold pattern portion when each cleaning operation has finished is obtained in the same manner below.

Next, the controller 130 generates, based on the total shape change obtained in step S907, dispensing patterns A, B, C, D, . . . each corresponding to the number of cleaning operations (step S908). The method of generating the dispensing patterns is the same as in FIG. 11 described in the first embodiment. The generation method includes a step of calculating the dispensing amount of the resin corresponding to a shape obtained by subtracting the total shape change from the three-dimensional shape of the mold pattern portion in an uncleaned stage. Finally, the controller 130 stores, in the storage unit 131, the plurality of dispensing patterns generated in step S908 (step S909).

Note that steps S901 and S903 are reversible. Steps S905 and S906 are also reversible.

(Imprint Method)

An imprint method using the dispensing patterns generated based on the number of cleaning operations and the cleaning method will now be described with reference to a flowchart shown in FIG. 21. The controller 130 executes a program related to the flowchart. The storage unit 131 stores the plurality of dispensing patterns generated by the aforementioned generation method. Further, each dispensing pattern is associated with the number of cleaning operations.

The processes in steps S910 to S913 are the same as in steps S100 to S103 in the first embodiment, and thus a description thereof will be omitted. The controller 130 sets information on the number of cleaning operations included in ID information obtained in step S911 (step S914). Next, the controller 130 selects the dispensing pattern corresponding to the number of cleaning operations out of the plurality of dispensing patterns stored in the storage unit 131 (step S915). A dispenser 110 dispenses the resin on the wafer in accordance with the dispensing pattern selected in step S915.

The processes in steps S917 to S921 are the same as in steps S107 to S111 in the first embodiment, and thus a description thereof will be omitted. The controller 130 determines a timing for performing cleaning (step S912). The controller 130 determines the timing based on whether the number of imprint processes has reached a predetermined number. Alternatively, conditions such as the number of wafers processed and an elapsed time may be set. When performing cleaning, the mold 101 is removed, the cleaning apparatus is caused to clean the mold 101, and a cleaning history (including only the number of cleaning operations or including the number of cleaning operations and the cleaning method) is added to the mold ID. Then, the process returns to step S910 to set the mold 101 again. If cleaning is not performed in step S922, the process returns to step S912 to set a new wafer and continue the imprint process.

According to this embodiment, the dispensing pattern is generated based on the shape change in the mold 101 by each cleaning method which changes every cleaning operation. The dispensing pattern used in the imprint process is generated based on the total shape change obtained in accordance with the combination of the cleaning methods that have been performed before the previous cleaning operations. Therefore, pattern defects such as unfilling defects can be reduced. Furthermore, the dispensing pattern considering that a degree of the shape change in the mold changes due to a difference in the cleaning method is used. Therefore, the pattern defects can further be reduced as compared with a case in which a dispensing pattern is prepared uniformly only based on the number of cleaning operations.

Note that the controller 130 may store, in the storage unit 131, the shape change corresponding to each cleaning method. If the user changes the cleaning condition (for example, performs the second-time cleaning step by the method 2), the controller 130 can generate a dispensing pattern corresponding to the changed condition.

Two molds slightly different from each other is used. The shape change in a case in which cleaning is performed by the method 1 may be obtained by using one of the molds. The shape change in a case in which cleaning is performed by the method 2 may be obtained by using the other mold.

### Sixth Embodiment

### Method of Continuing Imprinting by Using Dispensing Pattern Corresponding to Resin Pattern Change by Cleaning

Unlike the fifth embodiment, in the sixth embodiment, information concerning of a shape change in a mold pattern portion is not obtained by measuring a mold shape directly, but is obtained by measuring the shape of a resin pattern that has been formed by using a mold. A measurement method is the same as the aforementioned defect inspection. An imprint apparatus used in this embodiment is the same as in the fifth embodiment.

That is, instead of steps (steps S900, S902, and S904) of each measuring the three-dimensional shape of the mold 101 pattern portion, a step of measuring the shape of a resin pattern formed by using the mold 101 in an initial state, the shape of a resin pattern formed by using the mold 101 that has been cleaned by a method 1, and the shape of a resin pattern formed by using the mold 101 that has been cleaned by a method 2, respectively, are performed. Instead of steps (steps S904 and S905) of each obtaining the shape change in the mold 101 corresponding to a cleaning condition, a step of obtaining the shape change in each resin pattern corresponding to the cleaning condition is performed. Instead of a step (step S907) of obtaining the relationship between the number of cleaning operations and a total shape change in the mold 101, a step of obtaining the relationship between the number of cleaning operations and the shape change in each resin pattern is performed. A controller 130 determines a resin dispensing amount distribution needed after each cleaning operation. Furthermore, the controller 130 generates, based on a result of obtaining the relationship between the number of cleaning operations and the shape change in each resin pattern, a dispensing pattern needed after each cleaning operation.

Based on cleaning information recorded in the mold 101, the controller 130 selects, out of a generated plurality of dispensing patterns, an appropriate dispensing pattern to form on a wafer. According to this embodiment, it is possible to form a dispensing pattern needed after each cleaning step on the wafer by using a dispensing pattern generated in consideration of the number of cleaning operations and the cleaning condition. This makes it possible to reduce pattern defects such as unfilling defects. The sixth embodiment is advantageous over the fifth embodiment if it is easier to measure the shape of each resin pattern than to measure the three-dimensional shape of the mold pattern portion.

In the fifth and the sixth embodiments, the number of cleaning methods is not limited to two as long as the shape change in the mold 101 corresponding to each method is obtained. A different method means a case in which at least one cleaning condition included in each cleaning method is different. The cleaning conditions include, for example, the types of cleaning (dry-cleaning and wet-cleaning), the number of times of execution (execution time) of each cleaning method, and parameters related to cleaning.

In a case of a plasma module, the parameter related to cleaning in a dry-cleaning step includes, for example, the degree of vacuum, the type of gases, a gas pressure, the waveform of an applied voltage, temperature control of a wafer stage in a dry-cleaning apparatus, and a cleaning time. The parameter related to cleaning in a wet-cleaning step includes a cleaning solution, the concentration of the cleaning solution, the discharge amount (discharge amount per unit time) of the cleaning solution, a movement condition when cleaning is performed while moving the wafer, a movement condition when cleaning is performed while moving the orifice of the cleaning solution, and a cleaning time.

### Seventh Embodiment

### Method of Continuing Imprinting by Using Dispensing Pattern Corresponding to Shape Change in Mold Corresponding to Cleaning Condition and Number of Cleaning Operations

In the seventh embodiment, information indicating a way of cleaning on a mold at a specific timing is not recorded. At the time of determining a cleaning condition by a user or at the time of actually finishing cleaning, the user inputs the cleaning condition to an imprint apparatus and a controller 130 generates an optimal dispensing pattern based on the input cleaning condition. A storage unit 131 stores a program related to a method of generating the dispensing pattern and shown in a flowchart of FIG. 23. The imprint apparatus used in this embodiment is the same as in the fifth embodiment in other aspects.

For the sake of simplicity, a case in which the user can determine a cleaning step performed in one cleaning operation by arbitrarily combining six types of cleaning steps different in the cleaning condition will be described.

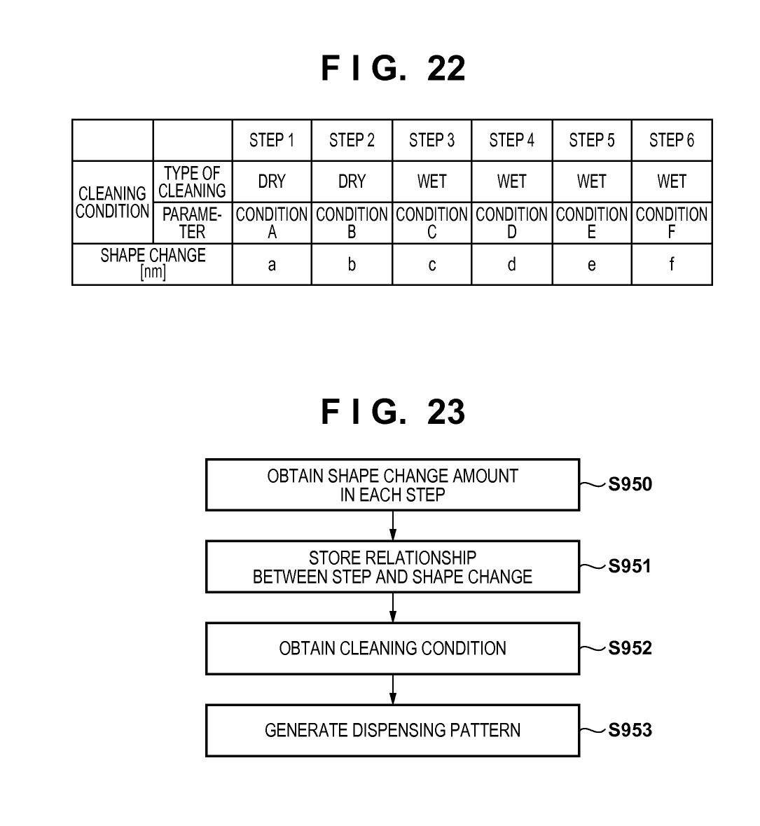

FIG. 22 is a table showing the list of cleaning conditions (the types of cleaning and parameters related to cleaning) in steps 1 to 6. In dry-cleaning, conditions A and B different in at least one parameter out of the aforementioned parameters related to dry-cleaning can be selected. In wet-cleaning, conditions C to F different in at least one parameter out of parameters related to wet-cleaning can be selected.

FIG. 23 is a flowchart showing a method of generating a dispensing pattern.

First, the controller 130 measures the shape of a mold pattern portion before and after performing cleaning by respective methods in steps 1 to 6, and obtains shape changes a to f by the respective steps (step S950). Note that the shape changes a to f may be obtained by the controller 130 based on the cleaning conditions and a measurement result input by the user or may be obtained upon receiving the shape changes obtained by the user.

The controller 130 stores, in a storage unit, information obtained by associating the steps and the shape changes with each other (step S951). The controller 130 obtains, from the user, information concerning of the combination of the steps used in one cleaning operation (step S952). The controller 130 generates a dispensing pattern (step S953).

For example, if the first-time cleaning operation is set to be performed in order of steps 3, 1, 5, and 6, the shape change in the mold 101 in this first-time cleaning operation is obtained as ΔD1=c+a+e+f. Therefore, the dispensing pattern after the first-time cleaning operation is generated by determining an appropriate dispensing amount and dispensing position of a resin if the shape of the mold 101 changes by ΔD1.

If the second-time cleaning operation is set as step 1+step 4, the shape change in the mold 101 caused only by the second-time cleaning operation is indicated by ΔD2=b+d. Therefore, a total shape change in the mold 101 caused by the first-time and second-time cleaning operations can be obtained as D2=ΔD1+ΔD2. The controller 130 generates a dispensing pattern by determining an appropriate dispensing amount and dispensing position of the resin if the shape of the mold 101 changes by ΔD2 (step S952).

As described above, information concerning of the shape change in the mold 101 by each cleaning method is accumulated in accordance with the combination of the cleaning conditions. By doing so, information concerning of the shape change in the mold 101 per cleaning operation is obtained. Information concerning of the shape change in the mold 101 up to the number of cleaning operations performed is accumulated as the cleaning operations are repeated. The dispensing pattern can be generated in consideration of the shape change in the mold 101 caused due to a cleaning operation by an arbitrary cleaning method set by the user. This makes it possible to form a desired pattern on the wafer even if the shape of the mold 101 changes by cleaning.

More than six types of information may be used, which is obtained in advance and associates the steps and the shape changes with each other. A larger amount of information can increase the type of cleaning conditions selectable by the user.

As in the sixth embodiment, in this embodiment, the shape change in the mold 101 may be obtained by measuring the shape of a resin pattern that has been formed by using the mold 101, instead of obtaining the shape change in the mold 101 directly by measuring the three-dimensional shape of a mold pattern portion.

Note that as in the fifth embodiment, this embodiment may be applied when obtaining the shape change in the mold 101 for each cleaning method. That is, the shape of each cleaning method may be obtained based on the shape change in the mold 101 for each cleaning step included in the respective cleaning methods.

An imprint method is the same as in the aforementioned embodiment, and thus a description thereof will be omitted.

Regarding the fifth to the seventh embodiments, between steps S900 and S901 or steps S902 and S903 in the fifth embodiment, a change amount corresponding to a predetermined number of imprint processes may be inserted in a step of forming a pattern. The dispensing pattern can be generated in consideration of the temporal change information of the shape of the mold pattern portion.

A defect inspection may be performed on a resin pattern formed by using the dispensing patterns that have been generated in the fifth to the seventh embodiments. A resin pattern with less defects can be formed by recreating a plurality of dispensing patterns corresponding to the number of cleaning operations based on obtained defect information and updating and storing it in the storage unit 131.

### Eighth Embodiment

If sequentially using two molds where the same three-dimensional patterns are formed, an individual difference in the three-dimensional shapes of the molds needs to be considered.

In the eighth embodiment, a controller 130 obtains information on the difference between the three-dimensional shapes of the respective molds in an initial state and stores it in a storage unit 131. This makes it possible to easily generate, based on individual difference information of the two molds and a dispensing pattern generated so as to correspond to the number of imprint processes of one of the molds, a dispensing pattern so as to correspond to the number of imprint processes of the other mold. As a result, time and effort of measuring a shape change in each mold can be saved.

This embodiment can be applied to not only a case in which the dispensing pattern is generated based on the number of imprint processes, but also a case in which a dispensing pattern corresponding to the number of cleaning operations is generated or a case in which a dispensing pattern corresponding to both the number of imprint processes and the number of cleaning operations is generated.

### Other Embodiments

A different shape change may occur depending on a timing for performing a cleaning method (or a cleaning step) even if the same cleaning method is used. For example, there is a case in which the shape change is x [nm] if the first-time cleaning operation is performed by a method 1, but the shape change is not x [nm] if the fourth-time cleaning operation is performed by the method 1. In this case, a resin pattern can be formed while further reducing pattern defects such as unfilling defects by obtaining the relationship between the shape change and the number of cleaning operations for each cleaning method (or cleaning step).

Another mode applicable to the first to the eighth embodiments will be described. A controller 130 may be integrated on one control board as long as it includes a required function or may be an aggregate of a plurality of control boards. Furthermore, a controller (generation unit) having a function of generating a dispensing pattern may be provided outside an imprint apparatus. Information can be exchanged with a cleaning apparatus by wired or wireless connection. A cleaning condition can be obtained without receiving information from a user or obtaining information from a mold.

Note that a cleaning apparatus can be provided outside an imprint apparatus or functionally included in the imprint apparatus. Only a particular cleaning method may be executed in the imprint apparatus. A time needed to convey the mold can be shortened.

The aforementioned respective embodiments can also be applicable to an imprint apparatus which forms a pattern by using not a photo-curing resin but a thermosetting resin.

<Method of Manufacturing Article>

A method of manufacturing an article according to an embodiment of the present invention is suitable for manufacturing an article, for example, a microdevice such as a semiconductor device or an element having a microstructure. The manufacturing method includes a step of forming a pattern on a substrate using an imprint apparatus. The manufacturing method can further include other known steps (oxidation, deposition, vapor deposition, doping, planarization, etching, resin peeling, dicing, bonding, packaging, and the like) of processing the substrate on which the pattern has been formed. The method of manufacturing the article according to this embodiment is advantageous in at least one of the performance, the quality, the productivity, and the production cost of the article, as compared with a conventional method.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-137065, filed Jul. 2, 2014, 2015-113352, filed Jun. 3, 2015, which are hereby incorporated by reference herein in their entirety.

What is claimed is:

1. A method for generating supply pattern data of an imprint material formed by using a mold, the method comprising the steps of:
obtaining, for each of a plurality of different cleaning methods, information on a shape change in a pattern portion of the mold caused by cleaning the pattern portion of the mold; and
generating, based on the obtained information concerning of the shape change corresponding to the cleaning method, the supply pattern data corresponding to the number of cleaning operations.

2. The method according to claim 1, wherein in the step of generating the supply pattern data comprising the step of obtaining information concerning of a total shape change in the mold based on a combination of the cleaning methods executed until the mold is cleaned by a predetermined number of times, and generating the supply pattern data corresponding to the predetermined number of times based on the obtained information concerning of the total shape change.

3. The method according to claim 1, wherein the information concerning of the total shape change is obtained by integrating shape changes respectively corresponding to the plurality of cleaning methods at a cleaning timing.

4. The method according to claim 1, wherein one of the plurality of cleaning methods includes a plurality of cleaning steps different in a cleaning condition, and
the method further comprising a step of obtaining information concerning of the shape change for each cleaning step, prior to the step of obtaining the information concerning of the shape change for each cleaning method.

5. The method according to claim 1, wherein in the step of obtaining the information concerning of the shape change for each cleaning method,
the information concerning of the shape change for each cleaning method is obtained based on a combination of respective cleaning steps included in the one cleaning method.

6. The method according to claim 1, further comprising a step of obtaining information concerning of a defect in the mold caused by a predetermined number of imprint processes,
wherein the step of generating the supply pattern data includes a step of generating, by using the obtained information concerning of the defect, supply pattern data corresponding to an imprint process to be executed after the number of imprint processes exceeds the predetermined number.

7. An imprint method comprising the steps of:
supplying an imprint material onto a substrate by using supply pattern data; and
forming a pattern on the substrate by using a mold and the imprint material supplied by the step of supplying,
wherein the supply pattern data is generated by a method of generating supply pattern data of the imprint material formed by using the mold, the method comprising the steps of:
obtaining, for each of a plurality of different cleaning methods, information concerning of a shape change in a pattern portion of the mold caused by cleaning the pattern portion of the mold; and
generating, based on the obtained information concerning of the shape change corresponding to the cleaning method, the supply pattern data corresponding to the number of cleaning operations.

8. An imprint apparatus which performs an imprint process for forming an imprint material on a substrate using a mold, the apparatus comprising:
a supply unit configured to supply the imprint material onto the substrate based on supply pattern data of the imprint material; and
a processing unit configured to perform the imprint process,
wherein the supply pattern data corresponds to the number of cleaning operations and information concerning of a shape change in a pattern portion of the mold caused by cleaning the pattern portion, wherein the shape change is different depending on cleaning methods.

9. A method of manufacturing an article, the method comprising the steps of:
forming a pattern of an imprint material on a substrate using an imprint apparatus which performs an imprint process for forming an imprint material on the substrate using a mold; and
processing the substrate on which the pattern has been formed in the step of forming,
wherein the imprint apparatus comprises:
a supply unit configured to supply the imprint material onto the substrate based on supply pattern data of the imprint material; and
a processing unit configured to perform the imprint process,
wherein the supply pattern data corresponds to the number of cleaning operations and information concerning of a shape change in a pattern portion of the mold caused by cleaning the pattern portion, wherein the shape change is different depending on cleaning methods.

10. A computer-readable storage medium storing a computer program, wherein the computer program causes a computer to perform a method for generating a supply pattern data of an imprint material formed by using a mold, the method comprising the steps:
obtaining, for each of a plurality of different cleaning methods, information concerning of a shape change in a pattern portion of the mold caused by cleaning the pattern portion of the mold; and
generating, based on the obtained information concerning of the shape change corresponding to the cleaning method, the supply pattern data corresponding to the number of cleaning operations.
